(19) United States
(12) Patent Application Publication
(10) Pub. No.: US 2026/0208185 A1
(43) Pub. Date: Jul. 23, 2026

(54) THREE-DIMENSIONAL MICROFLUIDIC DEVICE

(71) Applicants: UNIVERSITY HOSPITALS CLEVELAND MEDICAL CENTER, Cleveland, OH (US); CASE WESTERN RESERVE UNIVERSITY, Cleveland, OH (US)

(72) Inventor: Mohamed S. Draz, Cleveland, OH (US)

(21) Appl. No.: 19/138,273

(22) PCT Filed: Dec. 13, 2023
(86) PCT No.: PCT/US2023/083794

§ 371 Date: Jun. 12, 2025

Related U.S. Application Data
(60) Provisional application No. 63/387,174, filed on Dec. 13, 2022.

(51) Int. Cl. B01L 3/00

(52) U.S. Cl. CPC B01L 3/502707; B01L 3/502761; B01L 2200/16; B01L 2300/0681; B01L 2300/0877; B01L 2300/0887; B01L 2300/12; B01L 2400/0406; B01L 2400/0481

(57) ABSTRACT

A three-dimensional microfluidic device, comprising a screw having first threads and a nut having second threads cooperating with the first threads to define at least one microfluidic channel for receiving a fluid sample and providing flow of the fluid sample through the microfluidic channel and/or actuation/mixing of the flow of the fluid sample, wherein at least one of the first threads and the second threads is optionally functionalized with at least one reagent or affinity agent that is reactive with, separates, or captures at least one molecule or biological particle in the fluid sample.

This application claims priority from U.S. Provisional Application No. 63/387,174, filed Dec. 13, 2022, the subject matter of which is incorporated herein by reference in its entirety.

### GOVERNMENT FUNDING

This invention was made with government support under TW012056 awarded by the National Institutes of Health. The government has certain rights in the invention.

### TECHNICAL FIELD

The present invention relates generally to a fluid sample evaluation device, and specifically to a fluid sample evaluation device having a three-dimensional, microfluidic channel.

### BACKGROUND

Microfluidics are commonly used to manipulate fluids in a way to minimize the quantities of sample or reagents used in analyses to increase resolution in separations, signal accumulation, and detection, and to increase the speed of reaction by reducing the needed energy for reactants to form a product. Microfluidic devices that typically have at least one lateral dimension 10-1000 μm are now applied in biological testing, medical analysis, environmental monitoring, and engineering, and have transformed virtually every existing assay, from enzyme-linked immunoassay (ELISA) (for testing proteins) to polymerase chain reaction (PCR) (for testing nucleic acid). Repurposing existing materials and systems is increasingly becoming an attractive strategy to reduce the cost and time for technology development and implementation. Reusing material with microscale features and microfluidic capabilities, such as cellulose paper, proved to be especially useful for building disruptive low-cost microfluidics with applications in medicine and healthcare.

### SUMMARY

Embodiments described herein relate to an improved microfluidic device having a three-dimensional, fluid sample evaluation channel defined by mating threaded components.

In some embodiments, the three-dimensional microfluidic device can include a screw having first threads and a nut having second threads cooperating with the first threads to define at least one microfluidic channel for receiving a fluid sample. The screw and nut are configured to provide flow of the fluid sample through the microfluidic channel and/or actuation/mixing of the flow of the fluid sample. At least one of the first threads and the second threads is optionally functionalized with at least one reagent or affinity agent that is reactive with, separates, or captures at least one molecule or biological particle in the fluid sample.

In some embodiments, the fluid flow through the at least one microfluidic channel is passive.

In other embodiments, the fluid flow through the at least one microfluidic channel is via capillary action.

In some embodiments, the actuation/mixing of the flow of the fluid sample is performed by relative rotation between the nut and the screw

In other embodiments, the fluid sample can be loaded into the at least one microfluidic channel without moving the nut relative to the screw.

In some embodiments, the fluid sample is loaded into the at least one microfluidic channel in response to relative rotation between the nut and the screw.

In some embodiments, the screw extends entirely through the nut, whereas in other embodiments the nut covers an end of the screw.

In some embodiments, the screw and the nut are formed from an optically transparent material.

In some embodiment, the microfluidic device can further include a second nut having third threads cooperating with the first threads to define at least one second microfluidic channel for receiving the fluid sample. The at least one of the first threads and the third threads can optionally functionalized with at least one second reagent or second affinity agent that is reactive with, separates, or captures a second molecule or biological particle in the fluid sample different from the molecule or biological particle captured in the microfluidic channel defined by the first threads and second threads.

In some embodiments, the screw includes a fluid inlet and each of the nut and the second nut includes a fluid outlet. The fluid inlet and the fluid outlets are fluidly connected to the at least one microfluidic channel and the at least one second microfluidic channel.

In some embodiments, the screw includes an inlet for delivering the fluid sample to the microfluidic channel and the nut includes an outlet for removing the fluid sample from the microfluidic channel.

In some embodiments, the fluid sample is exposed to the first threads and the second threads.

In some embodiments, the affinity agent can include at least one of a bioaffinity ligand or cell that is functionalized to at least one of the first threads and the second threads. For example, the bioaffinity ligand can include at least one of a peptide, protein, nucleotide, antibody, CRISPR-associated protein, or aptamer.

In some embodiments, the reagent or affinity agent upon reacting, capturing, or separating the molecule or biological particle from the fluid sample provides a signal indicative of the reaction, capturing, or separation. The signal can include, for example, at least one of a detectable change in an optical, chemical, mechanical, magnetic, or electrical property of the reagent or affinity agent.

In some embodiments, the reagent can include an isothermal or non-isothermal based amplification solution that is configured for detection of a nucleotide in the fluid sample.

In some embodiments, the reagent can include a reverse transcription loop-mediated based solution that is configured for detection of a nucleotide in the fluid sample.

In some embodiments, the microfluidic device can further include a sieving medium provided in the at least one microfluidic channel. The sieving medium can be configured for sieving or separating the at least one molecule or biological particle in the fluid sample.

In some embodiments, a molecularly imprinted polymer can be provided in the at least one microfluidic channel. The molecularly imprinted polymer can be configured for sieving or separating the at least one molecule or biological particle in the fluid sample.

In some embodiments, at least one of the nut or the thread is a magnet or magnetized to separate or capture the at least one molecule or biological particle in the fluid sample. The magnetic field of the magnet can be one of gradient and constant.

In some embodiments, at least one of the first threads and the second threads can be permeated with pores to drain the fluid sample based on molecule or biological particle size.

In some embodiments, the size of the at least one microfluidic channel is configured to allow for flow of a single cell for single cell imaging and testing.

In some embodiments, the at least one microfluidic channel can include multiple microfluidic channels having different dimensions and functionalities for separating different biological particles. The different biological particles can include at least one of cells, microbes, and sub-microbial and sub-cellular structures from the fluid sample.

In some embodiments, the first threads and the second threads are made of different materials.

In some embodiments, the second threads can include an inner layer for filtering the at least one molecule or organism; and a top layer covering the inner layer and including pores for allowing the at least one molecule or biological particle to reach the inner layer in response to centrifugation. A third layer can be threaded onto the first threads for detecting the at least one molecule or biological particle.

In some embodiments, the first threads can include a first electrode and the second threads can include a second electrode for delivering electrical charge to enable electroporation of and/or drug delivery to multi/single molecules or biological particles trapped in the at least one microfluidic channel.

In some embodiments, the first threads and the second threads are microstructured or nanostructured to enhance drug to multi/single molecules or biological particles trapped in the at least one microfluidic channel.

In some embodiments, at least one of the first threads or the second threads can include a radiofrequency electrode or ultrasound transducer to enhance drug delivery to multi/single molecules or biological particles trapped in the at least one microfluidic channel.

In some embodiments, an object that can be trapped in the at least one microfluidic channel can allow better imaging and/or providing a signal. The object can include, for example at least one of a textile filament, an optical fiber, a flexible capillary tube, and a single metal filament to deliver a charge.

In some embodiments, the device can further include at least one of a growth medium and a gel/gel-like matrix provided between the first threads and the second threads for growing biological particles and/or studying their interactions and/or creating engineered cells/tissues.

In some embodiments, at least one of the first threads and the second threads are made of a material for enhancing imaging of the flowing fluid. For example, the imaging can include FRET and the material can used gold used with a fluid sample having a fluorescent dye.

In other embodiments, the imaging can include SERS and the material can include gold for enhancing a Raman signal.

In other embodiments, the imaging can include MRI/MPI and the material can include a magnetic material for magnetic signal quencher/enhancing.

Other embodiments described herein relate to three-dimensional microfluidic device. The device includes a screw having first threads. A first nut having second threads cooperates with the first threads to define a first microfluidic channel for receiving a fluid sample. At least one of the first threads and the second threads is optionally functionalized with at least one first reagent or first affinity agent that is reactive with, separates, or captures at least one first target molecule or biological particle in the fluid sample. A second nut having third threads cooperates with the first threads to define a second microfluidic channel for receiving the fluid sample. At least one of the first threads and the third threads is optionally functionalized with at least one second reagent or second affinity agent that is reactive with, separates, or captures at least one second molecule or biological particle in the fluid sample.

In some embodiments, relative rotation between the screw and the first nut causes the first reagent or first affinity agent to capture the first target molecule or biological particle within the fluid sample.

In other embodiments, relative rotation between the screw and the second nut causes the second reagent or second affinity agent to capture the second target molecule or biological particle within the fluid sample.

In some embodiments, a pitch of a first portion of the first threads receiving the first nut is different from a pitch of a second portion of the first threads receiving the second nut.

In some embodiments, the first and second reagents are different colors.

In other embodiments, the first and second reagents are separated from one another when the first and second nuts are positioned on the screw to prevent mixing of the first and second reagents during first target molecule or biological particle and/or the second target molecule or biological capture.

In some embodiments, the first and second nuts have different lengths along the screw.

Still other embodiments described herein relate to a system that includes at least one microfluidic device as described herein and an imaging system configured to detect through an optically transparent portion of the screw and/or nut an optical signature of the fluid sample.

In some embodiments, the system can further include a processor configured for comparing the determined optical signature to a control optical signature to identify a molecule or organism in the fluid sample.

Other embodiments described herein relate to a method for evaluating a biological fluid sample. The method includes providing a screw having first threads. A nut having second threads functionalized with a reagent and/or affinity agent is threaded onto the first threads to define at least one microfluidic channel. The biological fluid sample is injected into the microfluidic channel. Passive forces, such as gravity or capillary action, or non-passive forces are allowed to flow the biological fluid sample through the at least one microfluidic channel to cause the reagent and/or affinity agent to capture target molecules or biological particles within the biological fluid sample. The at least one microfluidic channel is imaged to quantify the captured target molecules or biological particles.

In some embodiments, the method further includes introducing the reagent and/or affinity agent into the second threads by compressing a soft or semi-soft, porous or non-porous, compliant container, such as at least one capsule, bead, bubble, or sac) containing the reagent and/or affinity agent. The capsule can be positioned at an inlet of the nut fluidly connected to the second threads.

In some embodiments, at least one of the nut or the thread is a magnet or magnetized to separate the fluid sample.

In some embodiments, a magnetic field of the magnet is one of gradient and constant.

In some embodiments, at least one of the first threads and the second threads is permeated with pores to drain the fluid sample based on size.

In some embodiments, the size of the at least one microfluidic channel is configured to allow for flow of a single cell for single cell imaging and testing.

In some embodiments, at least one microfluidic channel includes multiple microfluidic channels having different dimensions and functionalities for separating different biological particles including at least one of cells, microbes, and sub-microbial and sub-cellular structures from the fluid sample.

In some embodiments, the first threads and the second threads are made of different materials.

In some embodiments, the second threads include an inner layer for filtering the target cells and a top layer covering the inner layer and including pores for allowing the target cells to reach the inner layer in response to centrifugation. A third layer is threaded onto the second threads for detecting the target cells.

In some embodiments, the first threads include a first electrode and the second thread include a second electrode for delivering electrical charge to enable electroporation of multi/single cells trapped in the at least one microfluidic channel.

In some embodiments, the first threads and the second threads are microstructured or nanostructured to enhance drug delivery to multi/single cells trapped in the at least one microfluidic channel.

In other embodiments, the method further includes providing radiofrequency energy or ultrasound to multi/single cells trapped in the at least one microfluidic channel to enhance drug delivery.

In some embodiments, the method further includes integrating an object that can be trapped in the at least one microfluidic channel to allow better imaging and/or providing a signal.

In some embodiments, the object includes at least one of a textile filament, an optical fiber, a flexible capillary tube, and a single metal filament to deliver a charge.

In some embodiments, the method further includes providing at least one of a growth medium and a gel/gel-like matrix between the first threads and the second threads for growing biological particles and/or studying their interactions and/or creating engineered cells/tissues.

In some embodiments, at least one of the first threads and the second threads is made of a material for enhancing imaging of the flowing fluid.

In some embodiments, the imaging includes FRET and the material comprises gold used with a fluid sample having a fluorescent dye.

In other embodiments, the imaging includes SERS and the material comprises gold for enhancing a Raman signal.

In still other embodiments, the imaging includes MRI/MPI and the material comprises a magnetic material for magnetic signal quencher/enhancing.

Other objects and advantages and a fuller understanding of the invention will be had from the following detailed description and the accompanying drawings.

### BRIEF DESCRIPTION OF THE DRAWINGS

FIG. 1 is a schematic illustration of an example microfluidic device.

FIG. 2A is a side view of a screw of the microfluidic device.

FIG. 2B is a section view of a nut of the microfluidic device.

FIG. 3 is a photograph depicting a device for delivering a reagent to the microfluidic device.

FIG. 4 illustrates example multi-layered thread surfaces for the microfluidic device.

FIG. 5 illustrates another example microfluidic device.

FIGS. 6A-6C illustrate imaging of the microfluidic device.

FIGS. 7A-7C are photographs depicting fluid flow and actuation on a screw.

FIGS. 8A-8B are photographs depicting microfluidics using partially-capped screw systems.

FIGS. 9A-9C are photographs depicting microfluidics using fully-capped screw systems.

FIG. 10 depicts immunological testing on a screw.

FIG. 11 depicts immunological testing of human IgC using a developed lab-on-a-screw POC device.

FIGS. 12A-12D are photographs depicting nucleic acid testing of HIV-1 using the developed lab-on-a-screw POC device.

### DETAILED DESCRIPTION

To facilitate the understanding of this invention, a number of terms are defined below. Terms defined herein have meanings as commonly understood by a person of ordinary skill in the areas relevant to the present invention. Terms such as “a”, “an”, and “the” are not intended to refer to only a singular entity but also plural entities and also includes the general class of which a specific example may be used for illustration. The terminology herein is used to describe specific aspects of the invention, but their usage does not delimit the invention, except as outlined in the claims.

Throughout the description, where devices are described as having, including, or comprising, specific components, it is contemplated that devices also consist essentially of, or consist of, the recited components. Similarly, where methods or processes are described as having, including, or comprising specific process steps, the processes also consist essentially of, or consist of, the recited processing steps. Further, it should be understood that the order of steps or order for performing certain actions is immaterial so long as the compositions and methods described herein remains operable. Moreover, two or more steps or actions can be conducted simultaneously.

As used herein, the term “about” or “approximately” refers to a quantity, level, value, number, frequency, percentage, dimension, size, amount, weight or length that varies by as much as 15%, 10%, 9%, 8%, 7%, 6%, 5%, 4%, 3%, 2% or 1% to a reference quantity, level, value, number, frequency, percentage, dimension, size, amount, weight or length. In one embodiment, the term “about” or “approximately” refers a range of quantity, level, value, number, frequency, percentage, dimension, size, amount, weight or length ±15%, ±10%, ±9%, ±8%, ±7%, ±6%, ±5%, ±4%, ±3%, ±2%, or ±1% about a reference quantity, level, value, number, frequency, percentage, dimension, size, amount, weight or length.

It is further noted that the claims may be drafted to exclude any optional element. As such, this statement is intended to serve as antecedent basis for use of such exclusive terminology as “solely”, “only” and the like in connection with the recitation of claim elements, or the use of a “negative” limitation. “Optional” or “optionally” means that the subsequently described circumstance may or may not occur, so that the description includes instances where the circumstance occurs and instances where it does not.

The term “microchannels” as used herein refer to pathways through a medium, e.g., silicon, that allow for movement of liquids and gasses. Microchannels can therefore connect other components, i.e., keep components “in fluid communication.”

The term “microfabricated”, “micromachined”, and/or “micromanufactured” as used herein means to build, construct, assemble or create a device on a small scale, e.g., where components have micron size dimensions or microscale.

The term “polymer” as used herein refers to a substance formed from two or more molecules of the same substance. Polymers may also be linear polymers in which the molecules align predominately in chains parallel or nearly parallel to each other. In a non-linear polymer, the parallel alignment of molecules is not required.

The term “lensless image” or “lensless mobile imaging system” as used herein refers to an optical configuration that collects an image based upon electronic signals as opposed to light waves. For example, a lensless image may be formed by excitation of a charged coupled device (CCD) sensor by emissions from a light emitting diode.

The term “charge-coupled device (CCD)” as used herein refers to a device for the movement of electrical charge, usually from within the device to an area where the charge can be manipulated, for example, a conversion into a digital value. A CCD provides digital imaging when using a CCD image sensor where pixels are represented by p-doped MOS capacitors.

The term “patient” or “subject” as used herein is a human or animal and need not be hospitalized. For example, out-patients, persons in nursing homes are “patients.” A patient may comprise any age of a human or non-human animal and therefore includes both adult and juveniles, i.e., children. It is not intended that the term “patient” connote a need for medical treatment and, thus, a patient may voluntarily or involuntarily be part of experimentation whether clinical or in support of basic science studies.

The term “functionalized” or “chemically functionalized” as used herein means the addition of functional groups onto the surface of a material by chemical reaction(s). As will be readily appreciated by a person skilled in the art, functionalization can be employed for surface modification of materials in order to achieve desired surface properties, such as biocompatibility, wettability, and so on. Similarly, the term “biofunctionalization,” “biofunctionalized,” or the like, as used herein, means modification of the surface of a material to have desired biological function, which will he readily appreciated by a person of skill in the related art, such as bioengineering.

The term “sample” as used herein is used in its broadest sense and includes environmental and biological samples. Environmental samples include material from the environment such as soil and water. Biological samples may be animal, including, human, fluid, e.g., blood, plasma, and serum; solid, e.g., stool; tissue; liquid foods, e.g., milk; and solid foods, e.g., vegetables. A biological sample may comprise a cell, tissue extract, body fluid, chromosomes or extrachromosomal elements isolated from a cell, genomic DNA (in solution or bound to a solid support such as for Southern blot analysis), RNA (in solution or bound to a solid support such as for Northern blot analysis), cDNA (in solution or bound to a solid support) and the like.

The terms “capturing agent”, “bioaffinity ligand”, “binding component”, “ligand” or “receptor” as used herein may be any of a large number of different molecules, biological cells or aggregates, and the terms are used interchangeably. Each capturing agent may be immobilized on a solid substrate and binds to an analyte being detected. Proteins, polypeptides, peptides, nucleic acids (nucleotides, oligonucleotides and polynucleotides), antibodies, ligands, saccharides, polysaccharides, microorganisms such as bacteria, fungi, and viruses, receptors, antibiotics, test compounds (particularly those produced by combinatorial chemistry), plant and animal cells organdies or fractions of each and other biological entities may each be a capturing agent. Each, in turn, also may be considered as analytes if same bind to a capturing agent.

The terms “bind” or “adhere” as used herein include any physical attachment or close association, which may be permanent or temporary. Generally, an interaction of hydrogen bonding, hydrophobic forces, van der Waals forces, covalent and ionic bonding etc., facilitates physical attachment between the capturing agent and the analyte being measured. The “binding” interaction may be brief as in the situation where binding causes a chemical reaction to occur. That is typical when the binding component is an enzyme and the analyte is a substrate for the enzyme. Reactions resulting from contact between the capturing agent and the analyte are also within the definition of binding for the purposes of this application.

The term, “substrate” as used herein refers to surfaces as well as solid phases, which may include a microchannel. In some cases, the substrate is solid and may comprise polycarbonate. A substrate may also include components including, but not limited to, glass, silicon, quartz, plastic or any other composition capable of supporting photolithography.

Embodiments described herein relate generally to a fluid sample evaluation device, and specifically to a fluid sample evaluation device having a three-dimensional, microfluidic channel.

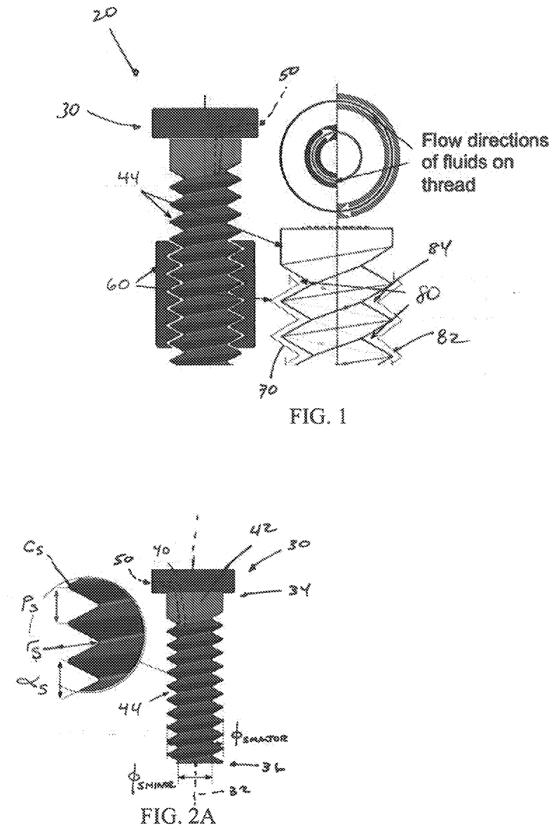

FIGS. 1-2B illustrate an example three-dimensional, microfluidic device 20. The device 20 includes a screw 30 and at least one nut 60. Referring to FIG. 2A, the screw 30 extends along a centerline or central axis 32 from a first end 34 to a second end 36. The first end 34 includes a head 40. A shaft 42 extends longitudinally from the head 40 to the second end 36. Threads 44 are provided along the length of the shaft 42. A passage 50 extends through the head 40 to the threads 44. The screw 30 can be made of an optically transparent material, such as polycarbonate. The threads 44 extend radially between a crest c_{S} and a root r_{S} and define major and minor diameters Φ_{SMAJOR}, Φ_{SMINOR}, respectively. The threads 44 have a pitch p_{S} and a thread angle α_{S}.

As shown in FIG. 2B, the nut 60 is generally cylindrical and includes a base 62 having an inner surface 64 defining an interior space 65. In this example, the interior space 65 extends the entire length of the nut 60. Alternatively, the interior space 65 can terminate at an end surface (not shown) transverse to the inner surface 64, i.e., the interior space can define a blind passage.

It will be appreciated that when the nut 60 shown is used with the screw 30, the microfluidic device 20 is colloquially referred to as a partially-capped screw system. On the other hand, when a nut 60 having the blind interior space 65 is used with the screw 30, the microfluidic device 20 is colloquially referred to as a fully-capped screw system. In other words, the nut 60 in this configuration covers the second end 36 of the screw 30. In any case, the interior space 65 defines an inlet 72 at the axial extent thereof. The nut 60 can be formed from an optically transparent material, such as polycarbonate. The nut 60 and screw 30 can be formed from the same material or different materials.

The inner surface 64 defines threads 70 provided along the length of the nut 60. A passage 74 extends radially from the threads 70 to the periphery of the base 62. The threads 70 extend radially between a crest c_{N} and a root r_{N} and define major and minor diameters Φ_{NMAJOR}, Φ_{NMINOR}, respectively. The threads 70 have a pitch p_{N} and a thread angle α_{N}.

The threads 44, 70 are configured to enable the nut 60 be threaded onto the screw 30 via relative rotation therebetween about the centerline 32. That said, when the nut 60 is threaded onto the screw 30, the threads 44, 70 cooperate define at least one microfluidic channel 80. Since the threads 44, 70 define the microfluidic channel(s) 80, each microfluidic channel has a three-dimensional, e.g., helical, shape. In one example, the screw threads 44 and roots r_{N} of the nut 60 cooperate to define a major microfluidic channel 82 having a first diameter. The nut threads 70 and roots r_{S} of the screw 30 cooperate to define a minor microfluidic channel 84 having a second diameter less than the first diameter. With this in mind, the threads 44, 70 can be configured to produce microfluidic channels 82, 84 with desired diameters, cross-sectional areas, lengths, etc.

It will also be appreciated that although a single nut 60 is shown, the microfluidic device 20 could include multiple nuts threaded along the length of the screw 30. In such a construction, at least one of the nuts 60 has the configuration shown in FIG. 2B to enable subsequent nut(s) to secure to the screw. When multiple nuts 60 are provided, a microfluidic channel 80 is formed between the threads 44 of the screw 30 and the threads 70 of each nut.

The nuts 60 can be identical to one another or different from one another. For example, the nuts 60 can be formed from different materials, have different lengths and/or have different threads 70 such that the microfluidic channels 80 are different from one another. The threads 44 on the screw 30 can therefore have portions with different pitches p_{S} to accommodate differently formed nuts 60.

Turning back to FIG. 1, the microfluidic device 20 is configured receive a fluid sample and enable flow of the fluid sample through the microfluidic channel 80 and/or actuation/mixing of the fluid sample. To this end, the passages 50, 74 in the respective screw 30 and nut 60 cooperate with the inlet 72 of the nut to act as fluid inlets and outlets for the microfluidic device 20. In one example, the fluid sample can be introduced through the passage 50 of the screw 30 and thereby flow to the threads 44.

Once the nut 60 is threaded to the screw 30, the fluid sample can flow through the inlet 72 into microfluidic channel 80 and exit the microfluidic device 20 at the passage 74. When multiple nuts 60 are provided, the passage 74 of each nut 60 cooperates with the passage 50 of the screw 30 to define the inlet/outlets of the microfluidic device 20. Regardless, the fluid sample can be exposed to the threads 44, 70.

Fluid flow through the microfluidic channel 80 can be passive, e.g., via gravity, or through capillary action. In one example, flow, actuation, and/or mixing of the fluid sample can occur without relative rotation between the screw 30 and the nut 60. In other words, the nut 60 is secured to the screw 30 and the fluid sample is introduced to the microfluidic channel 80 via gravity. Alternatively, flow, actuation, and/or mixing can be non-passive, for example, flow, actuation and/or mixing can occur in response to relative rotation between the screw 30 and the nut 60. That said, the fluid sample can be loaded into the microfluidic channel 80 without moving the nut 60 relative to the screw 30 or in response to relative rotation therebetween.

The fluid sample can include, for example, a biological fluid, such as blood, urine, plasma, synovial fluid, semen or sputum. The testing performed by the microfluidic device 20 can include, for example, measuring and/or detecting blood viscosity, blood coagulation, cell count/separation, biomarker presence, protein presence, nucleic acid presence, and/or cell sorting. With this in mind, at least one of the threads 44 of the screw 30 and the threads 70 of the nut 60 can be optionally functionalized with at least one reagent or affinity agent that is reactive with, separates, captures or binds to at least one target molecule or organism in the fluid sample. In other words, the microfluidic channel 80 can be functionalized.

In some embodiments, the at least one reagent or affinity agent can include, for example, bioaffinity ligands or adhesion molecules and/or capturing agents. The capturing agent or bioaffinity ligand can be adhered to, functionalized or chemically functionalized to the at least one surface of the microchannel. The bioaffinity ligands may be functionalized to the at least one surface of the microchannel covalently or non-covalently. A linker can be used to provide covalent attachment of a bioaffinity ligand to the surface of the microchannel. The linker can be a linker that can be used to link a variety of entities.

In some examples, the linker may be a homo-bifunctional linker or a hetero-bifunctional linker, depending upon the nature of the molecules to be conjugated. Homo-bifunctional linkers have two identical reactive groups. Hetero-bifunctional linkers have two different reactive groups. Various types of commercially available linkers are reactive with one or more of the following groups: primary amines, secondary amines, sulphydryls, carboxyls, carbonyls and carbohydrates. Examples of amine-specific linkers are bis(sulfosuccinimidyl) suberate, bis[2-(succinimidooxycarbonyloxy)ethyl]sulfone, disuccinimidyl suberate, disuccinimidyl tartarate, dimethyl adipimate 2HCl, dimethyl pimelimidate 2HCl, dimethyl suberimidate HCl, ethylene glycolbis-[succinimidyl-[succinate]], dithiolbis(succinimidyl propionate), and 3,3′-dithiobis(sulfosuccinimidylpropionate). Linkers reactive with sulfhydryl groups include bismaleimidohexane, 1,4-di-[3′-(2′-pyridyldithio)-propionamido)]butane, 1-[p-azidosalicylamido]-4-[iodoacetamido]butane, and N-[4-(p-azidosalicylamido)butyl]-3′-[2′-pyridyldithio]propionamide. Linkers preferentially reactive with carbohydrates include azidobenzoyl hydrazine. Linkers preferentially reactive with carboxyl groups include 4-[p-azidosalicylamido]butylamine.

Heterobifunctional linkers that react with amines and sulfhydryls include N-succinimidyl-3-[2-pyridyldithio]propionate, succinimidyl[4-iodoacetyl]aminobenzoate, succinimidyl 4-[N-maleimidomethyl]cyclohexane-1-carboxylate, m-maleimidobenzoyl-N-hydroxysuccinimide ester, sulfosuccinimidyl 6-[3-[2-pyridyldithio]propionamido]hexanoate, and sulfosuccinimidyl 4-[N-maleimidomethyl]cyclohexane-1-carboxylate. Heterobifunctional linkers that react with carboxyl and amine groups include 1-ethyl-3-[3-dimethylaminopropyl]-carbodiimide hydrochloride. Heterobifunctional linkers that react with carbohydrates and sulfhydryls include 4-[N-maleimidomethyl]-cyclohexane-1-carboxylhydrazide HCl, 4-(4-N-maleimidophenyl)-butyric acid hydrazide.2HCl, and 3-[2-pyridyldithio]propionyl hydrazide.

In some embodiments, a surface layer of 3-aminopropyl triethoxy silane (APTES) and/or (3-mercaptopropyl)trimethoxysilane (MTPMS) can be initially applied to surfaces of the microchannel followed by incubation with N-γ-maleimidobutyryl-oxysuccinimide ester (GMBS) to functionalize the bioaffinity ligand or capturing agent to the surfaces.

By way of example, a GMBS working solution can prepared by dissolving GMBS in DMSO and diluting with ethanol. A bioaffinity ligand described herein, such as an antibody or peptide, can be diluted with PBS to create a bioaffinity ligand working solution. The GMBS working solution can injected into the microchannels and incubated at room temperature. Following GMBS incubation, the microchannels can be washed. Next, the bioaffinity ligand working solution can injected into the microchannels and incubated at room temperature. The surface can then passivated by injecting a BSA solution incubated, thereby forming a bioaffinity ligand functionalized surface. The microchannels can be optionally rinsed with PBS before processing samples.

Alternatively, the bioaffinity ligands may be non-covalently coated onto a surface of the cell occlusion region. Non-covalent deposition of the bioaffinity ligand to the surface of the microchannel may involve the use of a polymer matrix. The polymer may be naturally occurring or non-naturally occurring and may be of any type including but not limited to nucleic acid, e.g., DNA, RNA, PNA, LNA, and the like or mimics, derivatives or combinations thereof, amino acid, e.g., peptides, proteins (native or denatured), and the like or mimics, derivatives or combinations thereof, lipids, polysaccharides, and functionalized block copolymers. The bioaffinity ligand may be adsorbed onto and/or entrapped within the polymer matrix. Alternatively, the bioaffinity ligand may be covalently conjugated or crosslinked to the polymer, e.g., it may be “grafted” onto a functionalized polymer.

An example of a suitable peptide polymer is poly-lysine, e.g., poly-L-lysine. Examples of other polymers include block copolymers that comprise polyethylene glycol (PEG), polyamides, polycarbonates, polyalkylenes, polyalkylene glycols, polyalkylene oxides, polyalkylene terepthalates, polyvinyl alcohols, polyvinyl ethers, polyvinyl esters, polyvinyl halides, polyvinylpyrrolidone, polyglycolides, polysiloxanes, polyurethanes, alkyl cellulose, hydroxyalkyl celluloses, cellulose ethers, cellulose esters, nitrocelluloses, polymers of acrylic and methacrylic esters, methyl cellulose, ethyl cellulose, hydroxypropyl cellulose, hydroxypropyl methyl cellulose, hydroxybutyl methyl cellulose, cellulose acetate, cellulose propionate, cellulose acetate butyrate, cellulose acetate phthalate, carboxylethyl cellulose, cellulose triacetate, cellulose sulphate sodium salt, poly(methyl methacrylate), poly(ethyl methacrylate), poly(butylmethacrylate), poly(isobutyl methacrylate), poly(hexylmethacrylate), poly(isodecyl methacrylate), poly(lauryl methacrylate), poly(phenyl methacrylate), poly(methyl acrylate), poly(isopropyl acrylate), poly(isobutyl acrylate), poly(octadecyl acrylate), polyethylene, polypropylene, poly(ethylene glycol), poly(ethylene oxide), poly(ethylene terephthalate), poly(vinyl alcohols), polyvinyl acetate, polyvinyl chloride, polystyrene, polyhyaluronic acids, casein, gelatin, glutin, polyanhydrides, polyacrylic acid, alginate, chitosan, poly(methyl methacrylates), poly(ethyl methacrylates), poly(butylmethacrylate), poly(isobutyl methacrylate), poly(hexylmethacrylate), poly(isodecyl methacrylate), poly(lauryl methacrylate), poly(phenyl methacrylate), poly(methyl acrylate), poly(isopropyl acrylate), poly(isobutyl acrylate), and poly(octadecyl acrylate), poly(lactide—17-glycolide), copolyoxalates, polycaprolactones, polyesteramides, polyorthoesters, polyhydroxybutyric acid, polyanhydrides, poly(styrene-b-isobutylene-b-styrene) (SIBS) block copolymer, ethylene vinyl acetate, poly(meth)acrylic acid, polymers of lactic acid and glycolic acid, polyanhydrides, poly(ortho)esters, polyurethanes, poly(butic acid), poly(valeric acid), and poly(lactide-cocaprolactone), and natural polymers such as alginate and other polysaccharides including dextran and cellulose, collagen, albumin and other hydrophilic proteins, zein and other prolamines and hydrophobic proteins, copolymers and mixtures thereof, and chemical derivatives thereof including substitutions and/or additions of chemical groups, for example, alkyl, alkylene, hydroxylations, oxidations, and other modifications routinely made by those skilled in the art.

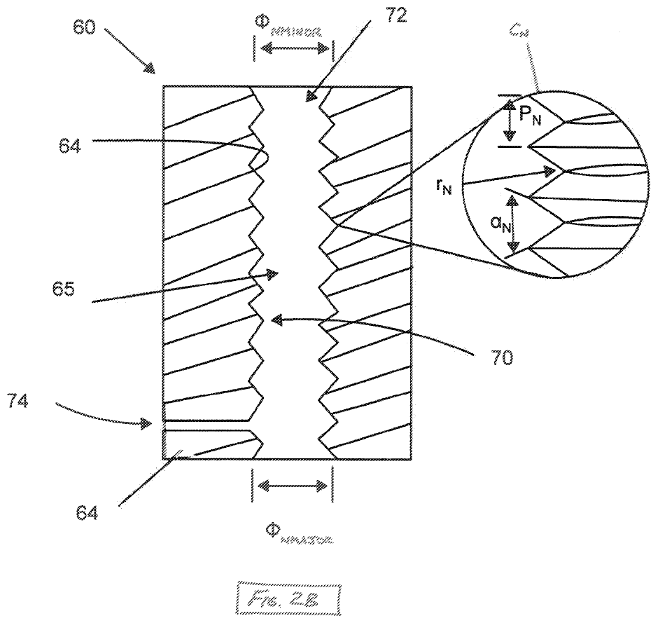

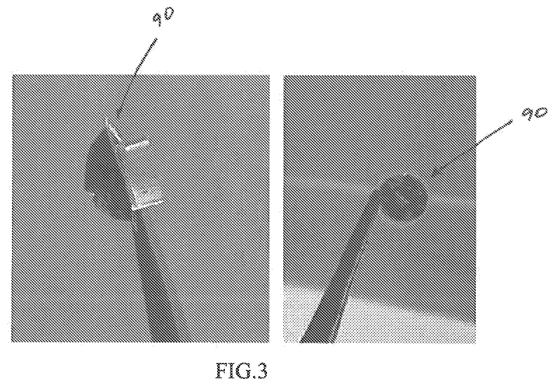

In one example shown in FIG. 3, the reagent and/or affinity agent can be introduced into the threads 70 by a container 90 a containing the reagent and/or affinity agent. The container 90 can include, for example, a soft or semi-soft, porous or non-porous, squeezable or compliant container, such as a soft or semi-soft, porous or non-porous, squeezable or compliant capsule, bead, bubble, or sac. The container 90 can be positioned at the passage 74 of the nut 60 fluidly connected to the threads 70 and compressed to urge the reagent and/or affinity agent into the passage 74 and ultimately onto the threads 70.

When multiple nuts 60 are utilized, the threads 70 of the second nut 60 defining a second microfluidic channel 80 with the threads 44 can optionally ben functionalized with at least one second reagent or second affinity agent that is reactive with, separates, captures or binds to a second target molecule or biological particle in the fluid sample different from the first target molecule or biological particle in the first microfluidic channel defined by the threads 44 and the threads 70 of the first nut. The same is true for third nuts 60, fourth nuts, etc.

In one example, the affinity agent is at least one of a bioaffinity ligand or cell that is functionalized to at least one of the threads 44 and/or the threads 70. The bioaffinity ligand can include at least one of a peptide, protein, nucleotide, antibody, CRISPR-associated protein, or aptamer.

In another example, the reagent or affinity agent upon reacting, separating, capturing or binding to the molecule or organism from the fluid sample, provides a signal indicative of the reaction, separation, capturing or binding. The signal can include at least one of a detectable change in an optical, chemical, mechanical, magnetic, or electrical property of the reagent or affinity agent, of the fluid sample, and/or of the microfluidic device 20.

In another example, the reagent includes an isothermal or non-isothermal based amplification solution that is configured for detection of a nucleotide in the fluid sample. Alternatively, the reagent includes a reverse transcription loop-mediated based solution that is configured for detection of a nucleotide in the fluid sample.

When a first reagent or first affinity agent is provided in the microfluidic device 20, relative rotation between the screw 30 and the nut 60 can cause the first reagent or first affinity agent to capture the first target molecule or biological particle within the fluid sample. When another nut 60 is provided on the screw 30 and functionalized with the second reagent or second affinity agent, relative rotation between the screw and the second nut can cause the second reagent or second affinity agent to capture the second target molecule or biological particle within the fluid sample.

The first reagent can be different from, e.g., a different color, the second reagent. Furthermore, the first and second reagents can be separated from one another when the first and second nuts 60 are positioned on the screw 30 to prevent mixing of the first and second reagents during capture of the first and second target molecules or biological particles.

In another example, a sieving medium can be provided in the microfluidic channel 80 and configured for sieving or separating target molecules in the fluid sample. To this end, the sieving medium can include a molecularly imprinted polymer for sieving or separating the at least one target molecule or biological particle in the fluid sample.

In lieu of or in addition to functionalizing one or both threads 44, 70, at least one of the screw 30, the nut 60 or the threads 44, 70 thereof can be formed from a magnet or magnetized to separate or capture the at least one target molecule or biological particle in the fluid sample. Moreover, the magnetic field generated by at least one of the screw 30, nut 60 or threads 44, 70 thereof can be a gradient or constant.

In another example, at least one of the threads 44, 70 can be permeated with pores for draining the fluid sample based on molecule or biological particle size. Alternatively or additionally, the microfluidic channel 80 can be configured to allow for flow of a single cell therethrough for single cell imaging and testing. Along the same lines, the major and minor microfluidic channels 82, 84 can have different dimensions and functionalities for separating different biological particles, the different biological particles including at least one of cells, microbes, and sub-microbial and sub-cellular structures from the fluid sample.

In another example shown in FIG. 4, the threads 70 of the nut 60 can be formed from multiple layers. To this end, the threads 70 can be formed from an inner layer for filtering the at least one target molecule or organism. A top layer covers the inner layer and has pores for allowing the at least one target molecule or biological particle to reach the inner layer in response to centrifugation. Following centrifugation, the top layer can be removed and replaced with a third layer configured for helping detect the at least one molecule or biological particle.

In another example shown in FIG. 5, the threads 44 form a first electrode and the threads 70 form a second electrode for delivering electrical charge to enable electroporation of and/or drug delivery to multi/single molecules or biological particles trapped in the microfluidic channel 80.

In another example, the threads 44 form a first electrode and the threads 70 form a second electrode to provide an impedance measuring system. The impedance measuring system can measure the impedance in the microchannel when a fluid sample containing cells, proteins, polypeptides, nucleic acids, or other biological molecules, passes through the microchannel.

The impedance measuring system can include a control unit (not shown), which can include a computer readable storage medium and a processor (not shown) configured to compare and/or determine changes of measured impedances of pairs of electrodes and provide real-time feedback to a subject of the results of the impedance measurement. These results, in turn, can be readily transmitted to a primary care provider and/or stored in a medical record database.

The impedance processing may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, a computer readable medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) can be encoded with one or more programs that, when executed on one or more computers or other processors, perform methods that implement the various embodiments described herein. The computer readable medium or media can be transportable, such that the program or programs stored thereon can be loaded onto one or more different computers or other processors to implement various aspects described herein. As used herein, the term “non-transitory computer-readable storage medium” encompasses only a computer-readable medium that can be considered to be a manufacture (i.e., article of manufacture) or a machine.

The terms “program” or “software” are used herein in a generic sense to refer to any type of computer code or set of computer-executable instructions that can be employed to program a computer or other processor to implement various aspects as discussed above. Additionally, it should be appreciated that according to one aspect of this embodiment, one or more computer programs that when executed perform methods of described herein need not reside on a single computer or processor, but may be distributed in a modular fashion amongst a number of different computers or processors to implement various aspects herein.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

The processor can determine cumulative impedance changes of pairs of electrodes flanking microchannel by comparing the impedance of the pair of electrodes before and after a fluid sample, such as a blood sample, is perfused through the microchannel.

In another example, at least one of the threads 44, 70 is microstructured or nanostructured to enhance drug delivery to multi/single molecules or biological particles trapped in the microfluidic channel 80. More specifically, at least one of the threads 44, 70 can be formed as a radiofrequency electrode or ultrasound transducer to enhancing drug delivery to multi/single molecules or biological particles trapped in the microfluidic channel 80. To this end, radiofrequency energy or ultrasound can be applied to at least one of the threads 44, 70 which, in turn, applies radiofrequency energy or ultrasound to the fluid sample in order to enhance drug delivery.

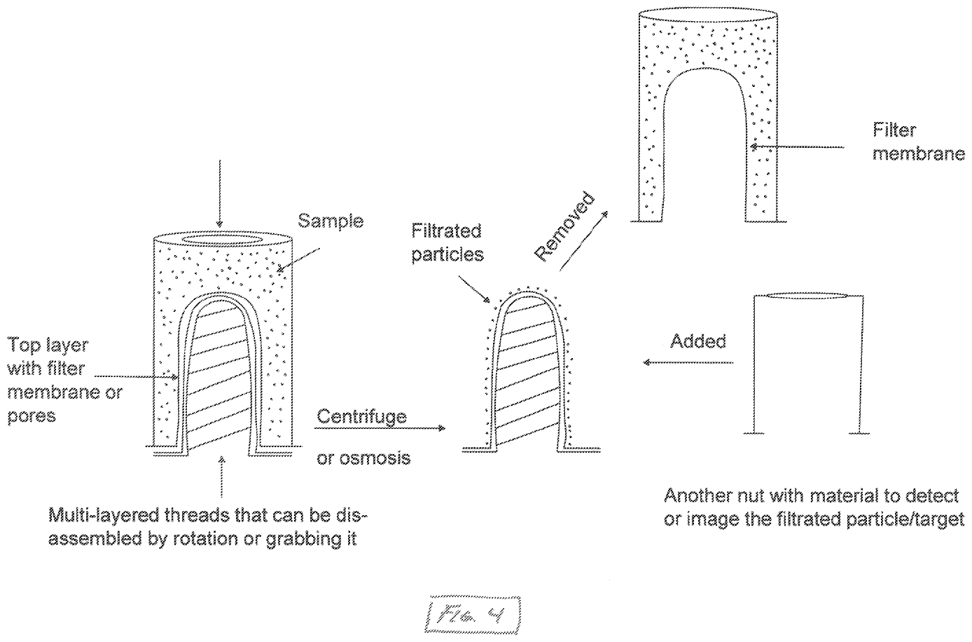

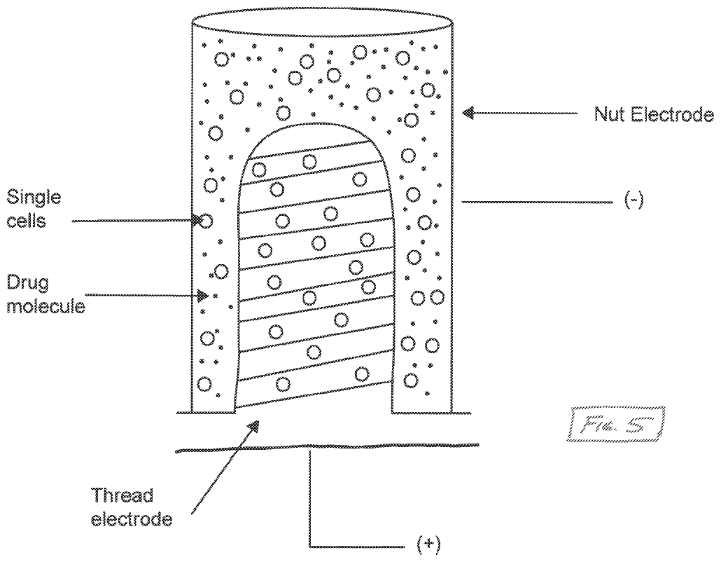

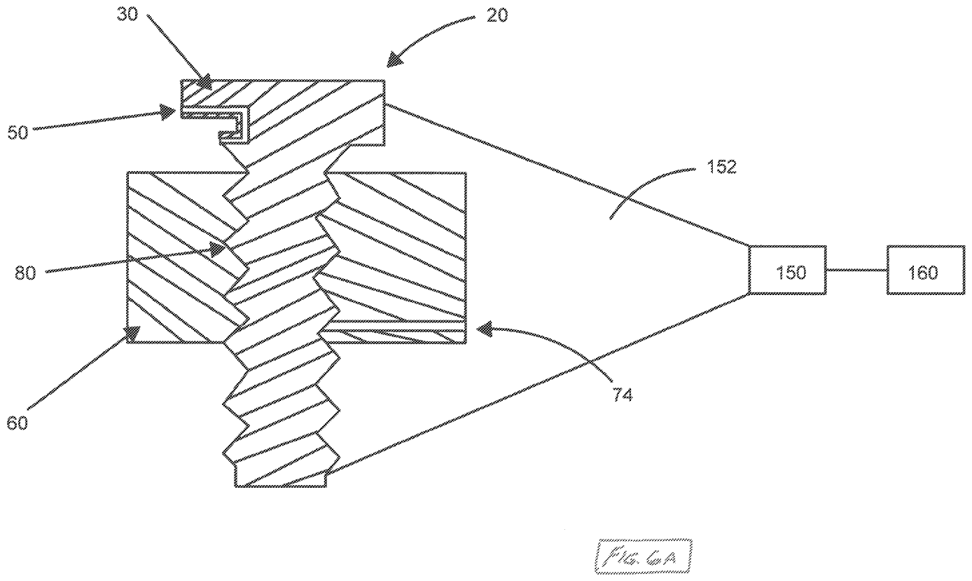

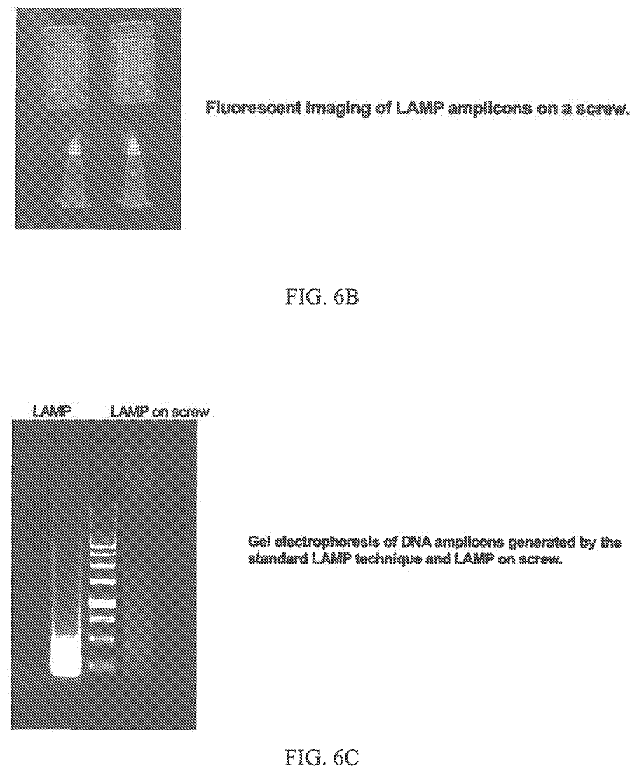

Referring to FIGS. 6A-6C, once the fluid sample is delivered to the microfluidic channel 80, the microfluidic device 20 can be analyzed to evaluate the reacted/separated/captured/bound at least one target molecule or biological particle in the fluid sample. In one example, an imaging system 150 is connected to a controller or processor 160 for imaging the microfluidic channel 80. To this end, the imaging system 150 has a field of view 152 extending over and around the microfluidic channel 80, and detects or determines an optical signature of the at least one target molecule or biological particle through the optically transparent portion of the screw 30 and/or nut 60.

To this end, the controller 160 receives signals from the imaging system 150 indicative of this determined optical signature and compares the determined optical signature to a control optical signature to identify a target molecule or organism in the fluid sample. The controller 160 then quantifies the imaged target molecules or biological particles based on the comparison. With this in mind, the microfluidic device 20 can include an object that can be trapped in the microfluidic channel 80 to allow better imaging and/or provide a signal. The object can include, for instance, one of a textile filament, an optical fiber, a flexible capillary tube, and a single metal filament to deliver a charge.

In some embodiments, the imaging system 150 that can detect and measure through the at least one optically transparent wall the of adhered, and/or captured molecules of interest within the microchannel. The imaging system 150 can be a lens-based imaging system, lensless imaging system, and/or mobile imaging system, e.g., cellular phone camera. The imaging system 150 can include a control unit (not shown), which can a include a computer readable storage unit and a processor to analyze the images of the microchannels and provide real-time feedback to a subject of the results of the image acquisition/analysis. The control unit can be shared with the control unit that configured to compare and/or determine changes.

In some examples, the imaging system can be a lens-based imaging system or a lensless/mobile imaging system. In some embodiments, the lensless imaging system can be a CCD sensor and a light emitting diode. By way of example, a fluorescent microscopy camera and an Olympus IX83 inverted, fluorescent motorized microscope with Olympus Cell Sense live-cell imaging and analysis software can be used to obtain real-time microscopic images. During real-time microscope imaging and high resolution video recording at 10 fps rate, controlled fluid flow with stepwise increments can be applied until cell detachment from the microchannel surface is observed. Videos can be converted to single frame images for further processing and analysis. The cell dimensions can then analyzed by using Adobe Photoshop software (San Jose, CA).

In some examples, a mobile imaging and quantification algorithm can be integrated into or with the microfluidic device. The algorithm can achieve reliable and repeatable test results for data collected in all resource settings of the microfluidic device.

In other examples, the microfluidic device can be configured to cooperate with a cellular phone having imaging capabilities. In such a case, the cellular phone can be provided with or capable of obtaining image analysis algorithms/software, e.g., via an online application. Images can be recreated by the cellular phone camera software and loaded into a custom phone application that identifies occluded and/or adhered biological molecules quantifies the number of occluded and/or adhered biological molecules, such as proteins or cells, in the image, and displays the results.

In other embodiments, the imaging system 150 can be configured to provide particle image velocimetry of fluid in the microchannels. For example, the imaging system 150 can be configured to take images of fluid as it passes through an imaging field of the microchannel. These images can be sent to control unit that includes a computer readable storage medium for storing the images and a processor that include executable instructions for receiving sequential images, generating general velocity vector maps based on successive images, and generating mean flow velocity data from the velocity vector maps. The mean flow velocity data can be output from the processor to a display as raw data or as visual representation of the mean flow velocity. The mean flow velocity data or map can be correlated to viscosity of the fluid using the processor or another processor that outputs the viscosity date of the fluid as raw data or as visual depiction.

The image processing may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

It will be appreciated that one or both materials of the screw 30 and nut(s) 60 can also be selected for enhancing imaging of the fluid sample. To this end, the imaging can be fluorescence resonance energy transfer (FRET) and the material of the screw 30 and nut 60 can include gold used with a fluid sample having a fluorescent dye provided therein. Alternatively, the imaging can be surface-enhanced Raman scattering (SERS) and the material of the screw 30 and nut 60 can include gold for enhancing the Raman signal. Alternatively, the imaging can be MRI/MPI and the material of the screw 30 and nut 60 can include a magnetic material for magnetic signal quencher/enhancing. FIGS. 6B and 6C illustrate several imaging techniques used with the microfluidic device 20.

In another example, at least one of a growth medium and a gel/gel-like matrix can be provided between the threads 44, 70 for growing biological particles and/or studying their interactions and/or creating engineered cells/tissues.

Providing at least one microfluidic channel between a threaded nut(s) and screw offers several advantages. Various types of the screw and screw-like materials can be modified to prepare multiple classes of systems with different functions and biomedical applications. Among the most prominent features of these systems is the three-dimensional helical nature of its microfluidic channels that enable (i) passive control of fluids with gravity and without the need of additional pumping or mechanical actuation, and (ii) spatial resolution for sensitive signal detection.

In particular, the threaded connection enables passive control of fluids without the need for additional, e.g., forced, actuation. This can be useful for developing low-cost medical devices that need microfluidic control using gravity forces, such as point of care (POC) diagnostics. On the other hand, actuating/introducing the fluid sample into the microfluidic channel by screwing the nut onto the screw is a simple, hand-controlled mechanical process that uses capillary action instead of gravity to control fluid transfer and mixing. Forced, screw-activated introduction of the fluid sample into the microfluidic channel can also help break biological, e.g., cells and/or tissues, and non-biological compartments and release their components. The screwing can also enhance uptake and delivery of small molecules and drugs into cells and cell-like systems.

The microfluidic device shown and described herein can produce a POC device for HIV screening and viral load testing (RNA quantitation). More specifically, the screw-inspired microfluidic technology (“ScrewChip”) can be integrated with CRISPR-dCas13 to enable rapid colorimetric testing of HIV RNA with high specificity and sensitivity. Amplification-free detection of HIV RNA can be achieved within 30 minutes and without the need for bulky equipment or extensive training.

### Example 1

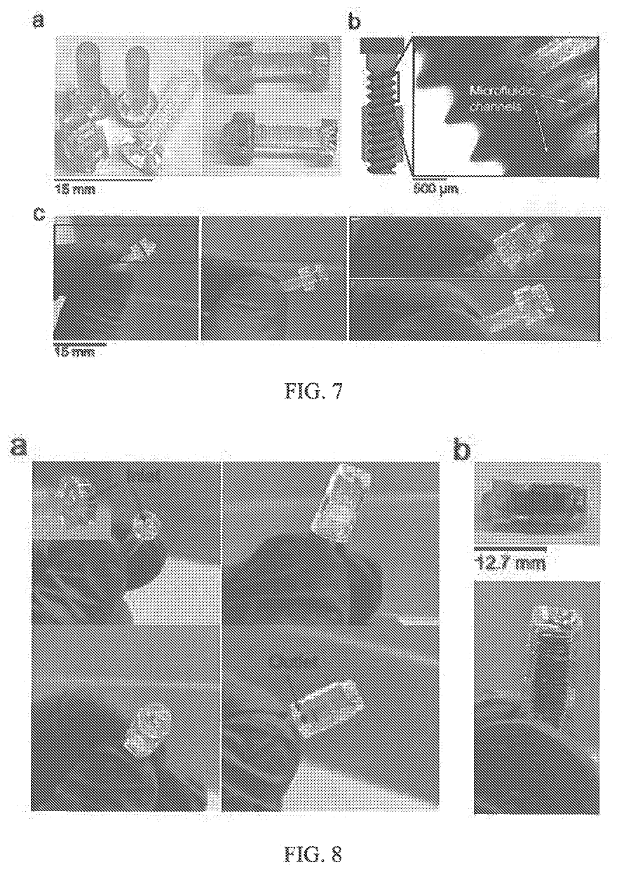

In this example, partially capped screws were loaded with multiple nuts (FIG. 7A). The screws were formed from transparent polycarbonate to allow clear visualization of colored solutions, such as gold nanoparticles. More specifically, 5 μl aliquots of gold nanoparticles (5 nm) were loaded on the surface of thread between the screw head and nut or two nuts (FIG. 7C). Light microscopy images were taken of the screw thread (FIG. 7B), showing its fine surface structure, and the helical directions of microfluidic channels.

### Example 2

In this example, the microfluidic device was made with a single threaded screw having an inlet connecting the screw head to its thread. One or multiple nuts that contained an outlet were provided on the screw (FIG. 8A). The device was loaded with different colored solutions in each of the different nuts (FIG. 8B). Digital images showed a precise control over loading of different solutions without passive mixing of the loaded solutions.

### Example 3

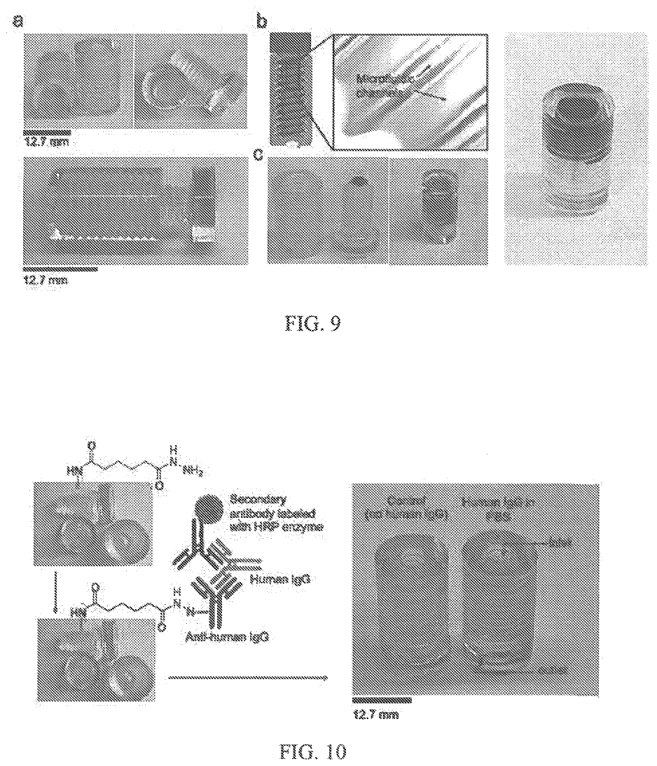

In this example, a fully-capped nut was threaded onto the screw. A digital image was taken (FIG. 9A). A light microscopy image of the screw thread was also taken (FIG. 9B), showing its fine surface structure, and the helical directions of the microfluidic channels. Single nut, passive fluid actuation and flow was achieved (FIG. 9C).

### Example 4

In this example, the threaded surface of a polycarbonate screw was modified with adipic dihydrazide to allow the directional conjugation of anti-human IgG monoclonal antibody to the surface of the screw thread (FIG. 10). An antibody functionalized thread was used for the detection of human IgG sample following ELISA technique. The target human IgG sample (75 μl of 0.1 μg/ml in PBS) was loaded on the microfluidic device and incubated for 20 minutes to allow the capture of the targeted human IgG, followed by 3 washing steps. The captured human IgG was then labeled with a secondary polyclonal antibody modified with HRP. After washing, the color changed to blue after the addition of TMB substrate.

### Example 5

In this example, immunological testing of human IgG was performed using a developed lab-on-a screw POC device (FIG. 11). The developed POC device was used for IgG testing using a working protocol similar to ELISA. It eliminated the need for pipetting and the sample could be directly loaded and detected in a single screw with very simplified washing. Improved color detection was achieved compared to the standard microwell plates used with ELISA.

### Example 6

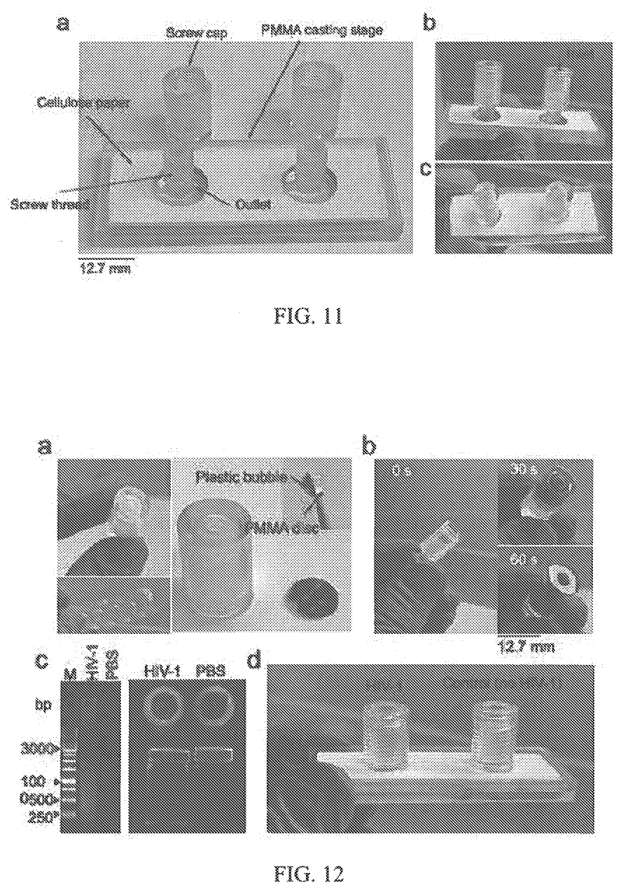

In this example, nucleic acid testing of HIV-1 was performed using the developed lab-on-a screw POC device. Key components of the screw-based microfluidic device developed for nucleic acid amplification are illustrated in FIG. 12A. Bubble wrap was used for loading and releasing of reagents. A PMMA disc was used for sealing the system to allow for nucleic acid amplification. The loading and release of reagents in the screw-based microfluidic device is shown in FIG. 12B. A plastic bubble was loaded into the system and reagents were released upon screwing the thread into its cap. FIG. 12C illustrates LAMP amplification of the screw following loading and release. The developed POC device used for HIV-1 nucleic acid testing using a working protocol similar to ELISA is shown in FIG. 12D.

### Example 7

In this example, rapid detection (<30 minutes) of HIV RNA in human blood was achieved. A lysis buffer was optimized to lyse plasma (with viral RNA) isolated by filtration from blood samples. The sample was heated with a mixture of platinum nanoprobes that were prepared with DNA oligonucleotides to specifically hybridize different sequences in a well-conserved region of HIV-1 pol-integrase gene. The sample was loaded on ScrewChip functionalized with CRISPR-dCas13 and incubated to allow specific capture of the target HIV RNA labeled with Pt-nanoprobes.

After a washing step, 3,3′,5,5′-tetramethylbenzidine (TMB) substrate solution was loaded on ScrewChip, and the presence of catalytically active-Pt nanoprobes changed the color from colorless to blue. A cellphone-based optical system can be enabled with an AI algorithm to detect the change in color and correlate it with viral RNA concentration in each tested sample.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

1. A three-dimensional microfluidic device, comprising:
a screw having first threads; and
a nut having second threads cooperating with the first threads to define at least one microfluidic channel for receiving a fluid sample and providing flow of the fluid sample through the microfluidic channel and/or actuation/mixing of the flow of the fluid sample, wherein at least one of the first threads and the second threads is optionally functionalized with at least one reagent or affinity agent that is reactive with, separates, or captures at least one molecule or biological particle in the fluid sample, wherein the screw includes an inlet for delivering the fluid sample to the microfluidic channel and the nut includes an outlet for removing the fluid sample from the microfluidic channel.

2. The microfluidic device recited in claim 1, wherein the fluid flow through the at least one microfluidic channel is passive or via capillary action.

3. (canceled)

4. The microfluidic device recited in claim 1, wherein the actuation/mixing of the flow of the fluid sample is performed by relative rotation between the nut and the screw.

5. The microfluidic device recited in claim 1, wherein the fluid sample is loaded into the at least one microfluidic channel without moving the nut relative to the screw or the fluid sample is loaded into the at least one microfluidic channel in response to relative rotation between the nut and the screw.

6. (canceled)

7. The microfluidic device recited in claim 1, wherein the screw extends entirely through the nut, and the nut covers an end of the screw.

8. (canceled)

9. The microfluidic device recited in claim 1, wherein the screw and the nut are formed from an optically transparent material.

10. The microfluidic device recited in claim 1, further comprising a second nut having third threads cooperating with the first threads to define at least one second microfluidic channel for receiving the fluid sample, wherein at least one of the first threads and the third threads is optionally functionalized with at least one second reagent or second affinity agent that is reactive with, separates, or captures a second molecule or biological particle in the fluid sample different from the molecule or biological particle captured in the microfluidic channel defined by the first threads and second threads.

11. The microfluidic device recited in claim 10, wherein the second nut includes a fluid outlet, wherein the fluid inlet of the screw and the fluid outlets of the nut and second nut are fluidly connected to the at least one microfluidic channel and the at least one second microfluidic channel.

12. (canceled)

13. (canceled)

14. The microfluidic device recited in claim 1, wherein the affinity agent comprises at least one of a bioaffinity ligand or cell that is functionalized to at least one of the first threads and the second threads.

15. The microfluidic device recited in claim 14, wherein the bioaffinity ligand includes at least one of a peptide, protein, nucleotide, antibody, CRISPR-associated protein, or aptamer.

16. (canceled)

17. The microfluidic device recited in claim 1, wherein the reagent or affinity agent upon reacting, capturing, or separating the molecule or biological particle from the fluid sample provides a signal indicative of the reaction, capturing, or separation.

18. The microfluidic device recited in claim 17, wherein the signal comprises at least one of a detectable change in an optical, chemical, mechanical, magnetic, or electrical property of the reagent or affinity agent.

19. The microfluidic device recited in claim 1, wherein the reagent comprises an isothermal or non-isothermal based amplification solution that is configured for detection of a nucleotide in the fluid sample and/or a reverse transcription loop-mediated based solution that is configured for detection of a nucleotide in the fluid sample.

20. (canceled)

21. The microfluidic device recited in claim 1, further comprising a sieving medium provided in the at least one microfluidic channel, the sieving medium configured for sieving or separating the at least one molecule or biological particle in the fluid sample.

22. (canceled)

23. The microfluidic device recited in claim 1, wherein at least one of the nut or the thread is a magnet or magnetized to separate or capture the at least one molecule or biological particle in the fluid sample.

24. (canceled)

25. The microfluidic device recited in claim 1, wherein at least one of the first threads and the second threads is permeated with pores to drain the fluid sample based on molecule or biological particle size.

26. (canceled)

27. The microfluidic device recited in claim 1, wherein the at least one microfluidic channel comprises multiple microfluidic channels having different dimensions and functionalities for separating different biological particles, the different biological particles including at least one of cells, microbes, and sub-microbial and sub-cellular structures from the fluid sample.

28. The microfluidic device recited in claim 1, wherein the first threads and the second threads are made of different materials.

29. The microfluidic device recited in claim 28, wherein the second threads comprise:
an inner layer for filtering the at least one molecule or organism; and
a top layer covering the inner layer and including pores for allowing the at least one molecule or biological particle to reach the inner layer in response to centrifugation, wherein a third layer is threaded onto the first threads for detecting the at least one molecule or biological particle.

30. The microfluidic device recited in claim 29, wherein the first threads comprise a first electrode and the second threads comprise a second electrode for delivering electrical charge to enable electroporation of and/or drug delivery to multi/single molecules or biological particles trapped in the at least one microfluidic channel.

31-67. (canceled)
